(19) United States
(12) Patent Application Publication
(10) Pub. No.: US 2017/0184202 A1
(43) Pub. Date: Jun. 29, 2017

(54) SEALING MEMBER

(71) Applicant: RACINGBROS INTERNATIONAL INCORPORATION, TAICHUNG CITY (TW)

(72) Inventor: MENG-TSUNG CHEN, TAICHUNG CITY (TW)

(21) Appl. No.: 14/979,774

(22) Filed: Dec. 28, 2015

(51) Int. Cl. F16J 15/3232; F16J 15/322

(52) U.S. Cl. CPC F16J 15/3232; F16J 15/322

(57) ABSTRACT

A sealing member includes an annular body and has a central hole. The body has an outer end and an inner end respectively formed on two ends of the central hole. At least one washer made of polytetrafluoroethylene is integrally connected to one of the outer and inner ends of the body. The body is made by rubber which provides a satisfactory sealing feature, and the at least one washer provides low friction, low wearing and high durability.

### BACKGROUND OF THE INVENTION

1. Fields of the Invention

The present invention relates to a sealing member, and more particularly, to a sealing member combined with a washer made by the material with the registered trademark “Teflon”.

2. Descriptions of Related Art

Generally, lubricant is applied to a movable or rotational part such as a shaft to provide lubrication to reduce wearing and friction when the shaft moves or rotates. There is a seal located between the hole and the shaft that extends through the hole so as to prevent the lubricant from leakage.

The conventional sealing member can be a single part or a multiple-portion part, wherein the single part is usually made by rubber which has good sealing feature, but the frictional efficient is high. Therefore, a significant resistance is generated when the shaft moves or rotates, and the resistance may cause deformation of the seal to cause leakage. In the market, there is a rubber sealing member combined with Teflon guide member, or combined with other metallic part. The Teflon guide member provides low friction, low viscosity and high durability.

The conventional multiple-portion part can be installed by way of mounting or engaging. For the sealing member that is mounted to the shaft, the sealing member is made by a process of pressing a thin and flat Teflon plate into ring-shaped guide members; a process of heating and molding to form a curved guide face, and the ring-shaped guide member is applied with treatment of heating to remove stress when being pressing, and a process of removing the molding set to get the guide member with a curved guide face along the hole of the guide member. The guide member is then connected with an annular metallic case. Rubber is then mounted to outside of the case so as to form a sealing member. However, the processes mentioned above may have accumulated tolerances which make the sealing member to be uneven and therefore cause higher friction. The sealing member cannot provide satisfied sealing feature. Besides, the manufacturing processes involve high manufacturing cost.

For the sealing member that is engaged with the shaft, the sealing member has an annular part which has multiple grooves defined in the inner periphery of the hole of the sealing member, and each groove has a Teflon guide member engaged therewith. This type of the sealing members has similar shortcomings as those mounted to the shaft.

The present invention intends to provide a sealing member to eliminate the shortcomings mentioned above.

### SUMMARY OF THE INVENTION

The present invention relates to a sealing member and comprises an annular body and has a central hole. The body has an outer end and an inner end respectively formed on two ends of the central hole. At least one washer made of material with registered trademark “Teflon” is integrally connected to one of the outer and inner ends of the body. The body is made by rubber which provides satisfied sealing feature, and the at least one washer provides low friction, low wearing and high durability.

The Teflon washer is put in the molding set when making the rubber body of the sealing member so that the Teflon washer is integrally formed with the rubber body. The Teflon washers can be connected to the inner and/or outer ends of the body to prolong the life of the sealing member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the sealing member of the present invention, partly removed for illustration purpose;

FIG. 2 is an exploded view of the sealing member of the present invention;

FIG. 3 is a cross sectional view of the sealing member of the present invention;

FIG. 4 is a partial cross sectional view to show that the sealing member of the present invention is cooperated with a suspension device;

FIG. 5 shows the comparison of friction coefficients between the sealing member of the present invention and a conventional rubber sealing member;

FIG. 6 is a cross sectional view of the second embodiment of the sealing member of the present invention;

FIG. 7 is a partial cross sectional view to show that the second embodiment of the sealing member of the present invention is cooperated with a suspension device;

FIG. 8 is a cross sectional view of the third embodiment of the sealing member of the present invention;

FIG. 9 is a partial cross sectional view to show that the third embodiment of the sealing member of the present invention is cooperated with a suspension device;

FIG. 10 is a cross sectional view of the fourth embodiment of the sealing member of the present invention, and

FIG. 11 is a partial cross sectional view to show that the fourth embodiment of the sealing member of the present invention is cooperated with a suspension device.

### DETAILED DESCRIPTION OF THE PREFERRED EMBODIMENT

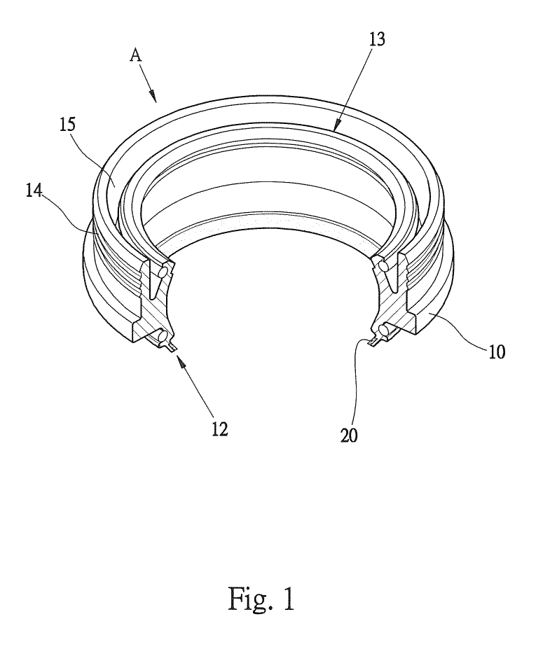

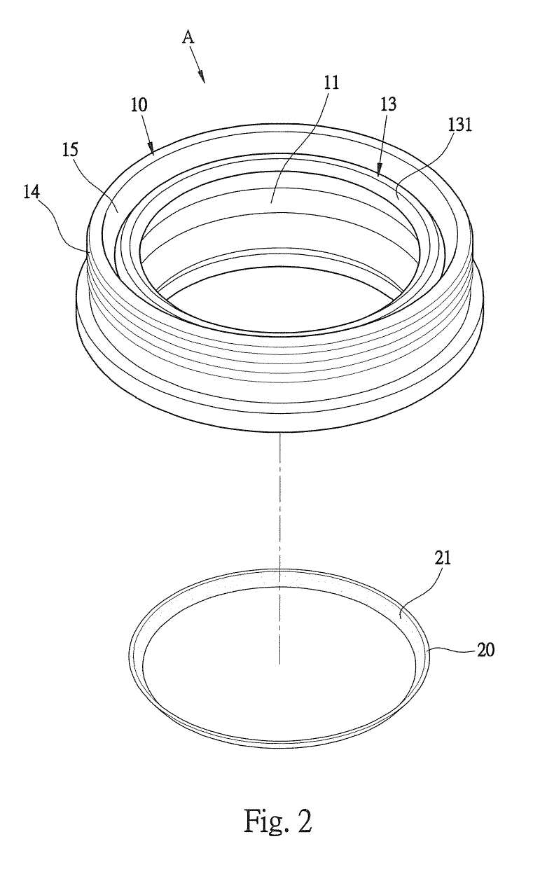

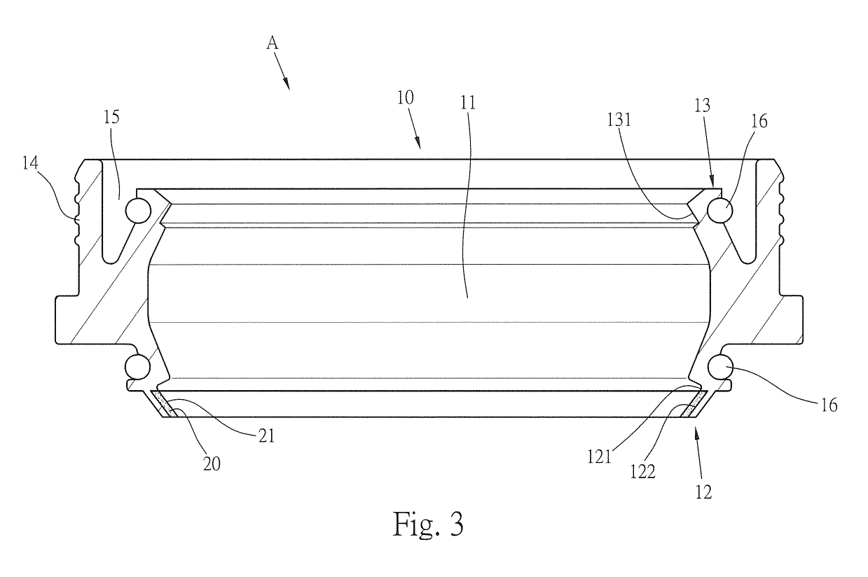

Referring to FIGS. 1 to 3, the sealing member “A” of the present invention comprises a body 10 made by runner and the body 10 is an annular body and has a central hole 11. The body 10 has an outer end 12 and an inner end 13 respectively formed on two ends of the central hole 11. The outer end 12 has a recessed and curved first inner face 121 defined in the inner periphery thereof. The inner end 13 has a recessed and curved second inner face 131 defined in the inner periphery thereof. A curved first engaging face 122 is formed in the inner periphery of the first inner face 121 of the outer end 12 and located away from the inner end 13. An annular skirt 14 extends from the outer periphery of the body 10 and axially toward the outer end 13 of the body 10. The distal end of the skirt 14 axially protrudes beyond the distal end of the outer end 13 of the body 10. A gap 15 is defined between the inner periphery of the skirt 14 and the outer periphery of the outer end 12 of the body 10. A ring 16 is mounted to the outer periphery of each of the inner end 13 and the outer end 12 to secure the sealing member “A” to an object.

At least one washer 20 made of the material with the registered trademark “Teflon” is integrally connected to one of the outer and inner ends 12, 13 of the body 10. The at least one washer 20 is put in the molding set when making the rubber body 10 of the sealing member “A” so that the at least one washer 20 is integrally formed with the first engaging face 122 of the outer end 12 of the rubber body 10. The inner periphery 21 of the at least one washer 20 is in flush with the first inner face 121 of the outer end 12 of the body 10 to form the sealing member “A”.

The washer 20 is integrally formed with the pre-set position of the body 10 so as to reduce the accumulated tolerances. The “Teflon” provides low friction and heat-durability so that the washer 20 has longer life and the sealing feature is increased.

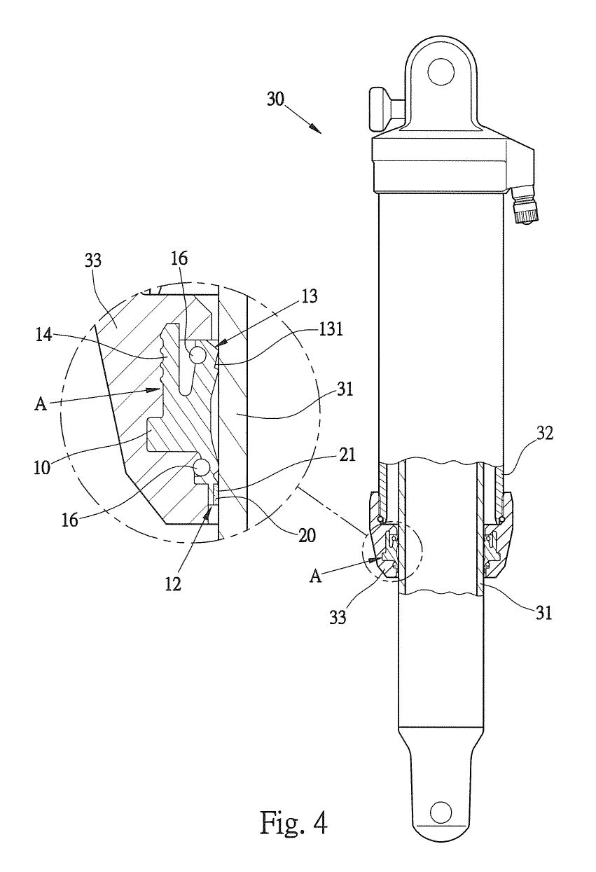

As shown in FIG. 4, a suspension device 30 of a vehicle is disclosed, the suspension device 30 has an inner cylinder 31 and an outer cylinder 32 in which the inner cylinder 31 is retractably inserted. A mounting part 33 is mounted to the inner cylinder 31 and an end of the outer cylinder 32. Lubricant is applied between the inner and outer cylinders 31, 32, and the sealing member “A” is located at the inner periphery of the mounting part 33. The inner cylinder 31 extends through the central hole 11 of the body 10. By the rings 16, the body 10 securely mounted to the outside of the inner cylinder 31. The first inner face 121 of the outer end 12 of the body 10, the inner face 21 of the washer 20, the second inner face 131 of the inner end 13 respectively contact the outer periphery of the inner cylinder 31.

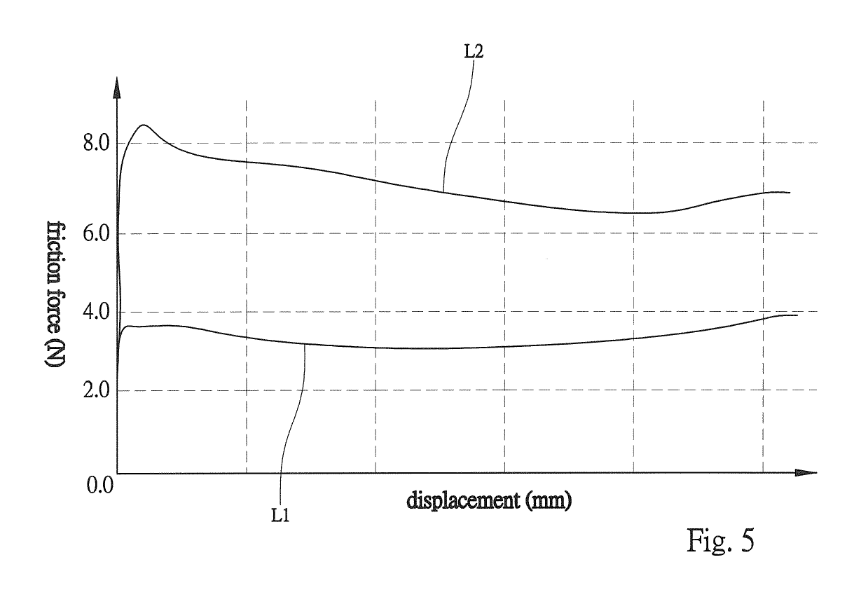

As shown in FIG. 5, the comparison of friction coefficients between the sealing member “A” of the present invention and a conventional rubber sealing member is disclosed, wherein the X-axis represents the displacement (mm) and the Y-axis represents the friction force (N). The first curve L1 represents the sealing member “A” of the present invention, and the second curve L2 represents the conventional rubber sealing member. It clearly shows that the friction efficient of the sealing member “A” of the present invention is much lower than that of the conventional rubber sealing member.

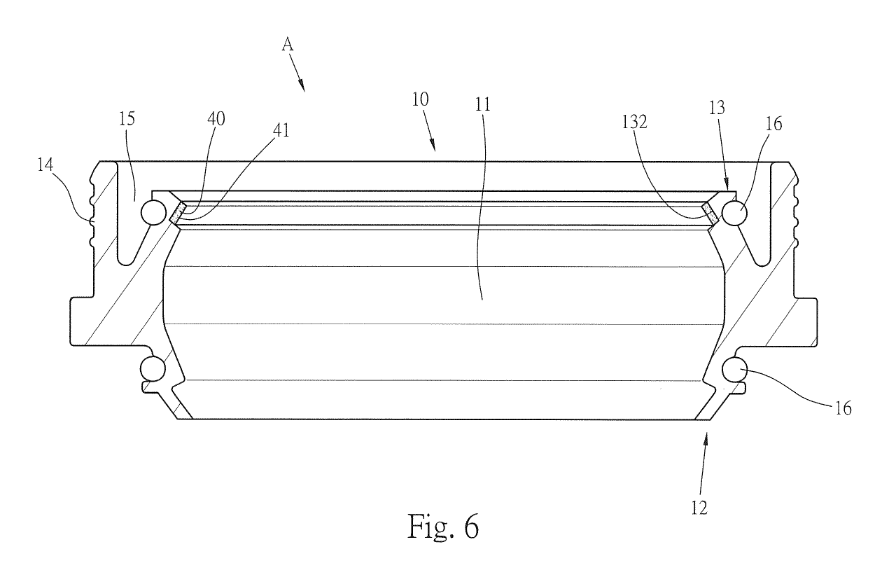

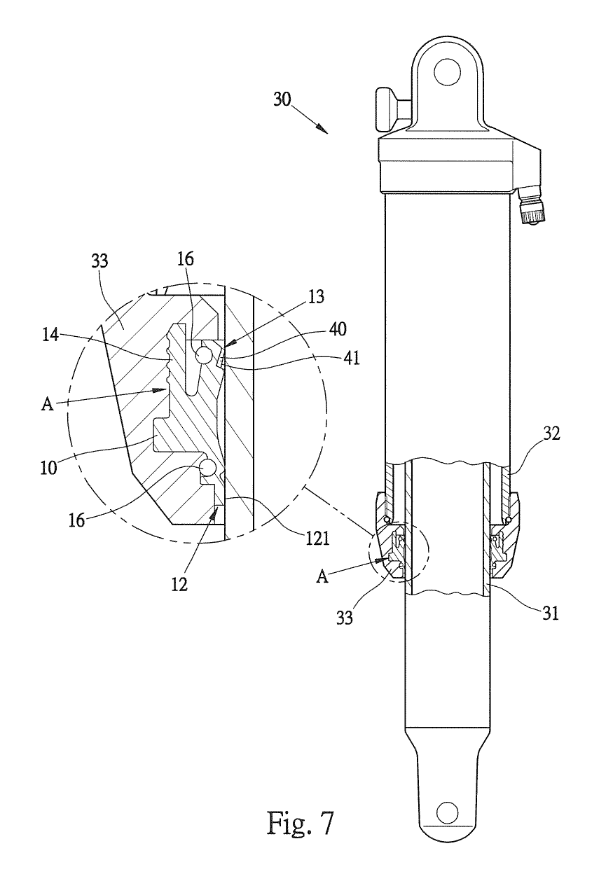

As shown in FIGS. 6 and 7, the second embodiment of the present invention is disclosed, wherein a curved second engaging face 132 is formed in an inner periphery of the second inner face 131 of the inner end 13, and the washer 40 is integrally connected to the second engaging face 132 by the same method as mentioned above. The sealing member “A” of the second embodiment is cooperated with the suspension device, the first inner face 121 of the outer end 12 of the body 10 and the inner periphery 41 of the washer 20 respectively contact the outer periphery of the inner cylinder 31.

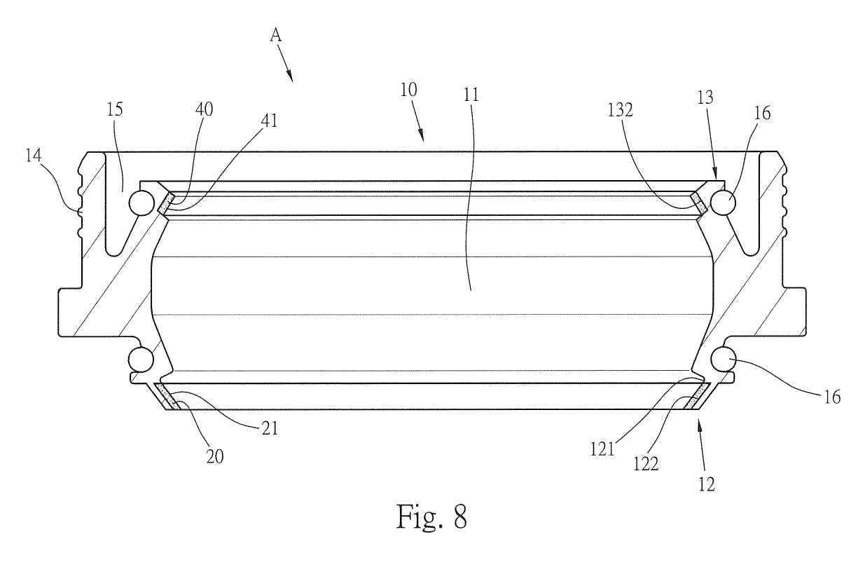

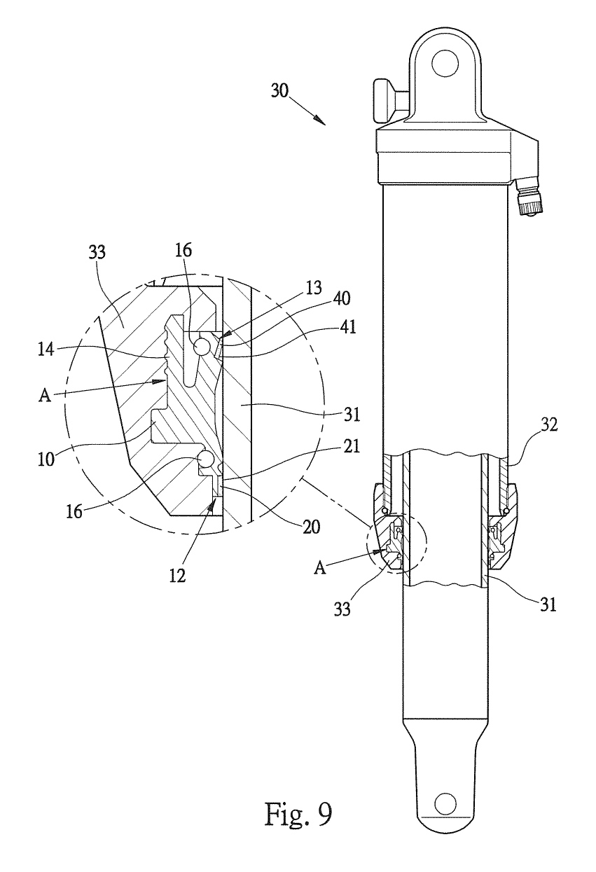

As shown in FIGS. 8 and 9, the third embodiment of the present invention is disclosed, the outer end 12 has a recessed and curved first inner face 121 defined in the inner periphery thereof, and the inner end 13 has a recessed and curved second inner face 131 defined in the inner periphery thereof. Each of the inner end 13 and the outer end 12 has a curved second/first engaging face 132/122 formed in the inner periphery thereof. Two washers 20, 40 are respectively and integrally engaged with the first engaging face 122 and the second engaging face 132 by installing the two washers 20 in the molding set when making the rubber body 10 of the sealing member “A” so that the two washers 20, 40 are respectively and integrally engaged with the first engaging face 122 and the second engaging face 132. The sealing member “A” of the third embodiment is cooperated with the suspension device, the inner cylinder 31 extends through the central hole 11 of the body 10, the inner periphery 21 of the washer 20 on the outer end 12 of the body, and the inner periphery 41 of the washer 40 on the inner end 13 respectively contact the outer periphery of the inner cylinder 31.

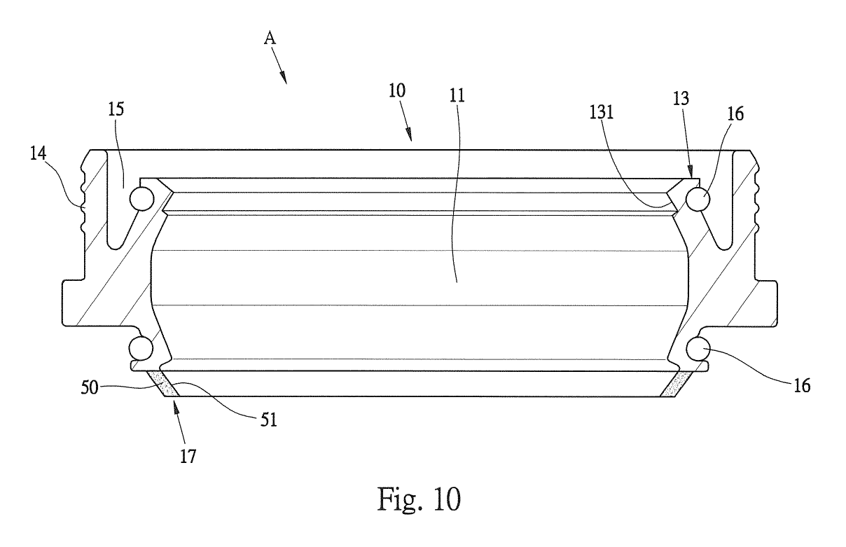

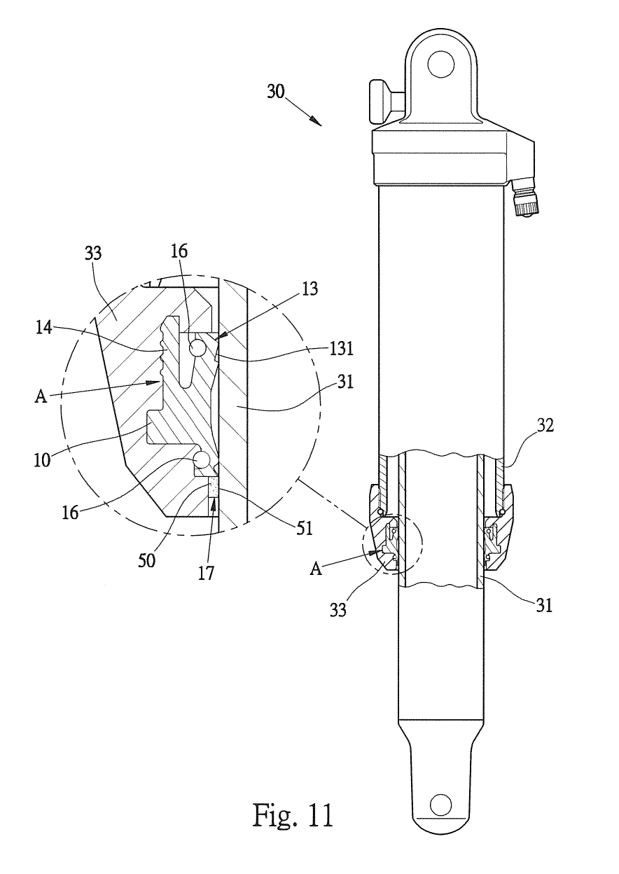

As shown in FIGS. 10 and 11, the fourth embodiment of the present invention is disclosed, the two washer 50 is put in the molding set when making the rubber body 10 of the sealing member “A”, the washer 50 is connected to the outer end 12 of the body 10 and forms an annular distal end 17 of the outer end 12. The washer 50 is located away from the inner end 13 and the annular distal end 17 provides lower friction and high sealing feature. The inner cylinder 31 extends through the central hole 11 of the body 10, the inner periphery 51 of the washer 50 on the annular distal end 17 of the body 10, and the second inner face 131 of the inner end 13 respectively contact the outer periphery of the inner cylinder 31.

The sealing member “A” of the present invention includes at least one washer 20 integrally connected thereto when manufacturing the sealing member “A”, the at least one washer 20 is made by “Teflon” so that the sealing feature is improved, and the life of use of the sealing member “A” is prolonged.

While we have shown and described the embodiment in accordance with the present invention, it should be clear to those skilled in the art that further embodiments may be made without departing from the scope of the present invention.

1. A sealing member comprising:
a body being an annular body and having a central hole, the body has an outer end and an inner end respectively formed on two ends of the central hole, and
at least one washer made of polytetrafluoroethylene being integrally connected to an inner periphery of at least one of the outer and inner ends of the body,
wherein the outer end has a recessed and curved first inner face defined in an inner periphery thereof, a curved first engaging face is formed in an inner periphery of the first inner face of the outer end and located away from the inner end, the inner end has a recessed and curved second inner face defined in an inner periphery thereof, a curved second engaging face is formed in an inner periphery of the second inner face of the inner end, the at least one washer has an annular frustoconical shaped inner face, the inner face being a low friction sealing surface.

2. The sealing member as claimed in claim 1, wherein the at least one washer is a single washer integrally connected to the first engaging face.

3. The sealing member as claimed in claim 1, wherein the at least one washer is a single washer integrally connected to the second engaging face.

4. The sealing member as claimed in claim 1, wherein two washers are respectively and integrally engaged with the first engaging face and the second engaging face.

5. The sealing member as claimed in claim 1, wherein the at least one washer is connected to the outer end of the body and forms an annular distal end of the outer end.

6. The sealing member as claimed in claim 1, wherein an annular skirt extends from an outer periphery of the body and axially toward the inner end of the body, a distal end of the skirt axially protrudes beyond a distal end of the inner end of the body, a gap is defined between an inner periphery of the skirt and an outer periphery of the outer end of the body.

7. The sealing member as claimed in claim 1, wherein the body is made by rubber.

8. The sealing member as claimed in claim 1, wherein two rings are respectively mounted to two respectively outer peripheries of the outer end and the inner end.
